(19) United States
(12) Patent Application Publication
(10) Pub. No.: US 2019/0214753 A1
(43) Pub. Date: Jul. 11, 2019

(54) U2 FEMALE ADAPTER

(71) Applicant: AMPHENOL EAST ASIA ELECTRONIC TECHNOLOGY (SHEN ZHEN) CO., LTD., Shen Zhen (CN)

(72) Inventors: FU-AN JIANG, SHEN ZHEN (CN); Lei Liao, SHEN ZHEN (CN); Yan-Bin Tan, SHEN ZHEN (CN); Yi-Tao Zhang, SHEN ZHEN (CN)

(21) Appl. No.: 15/863,435

(22) Filed: Jan. 5, 2018

(51) Int. Cl. H01R 12/72

(52) U.S. Cl. CPC H01R 12/721

(57) ABSTRACT

An U2 female adapter with a special mask structure includes a terminal part, a conductive member, and a housing part. The terminal part includes a plurality of grounding terminals. The housing part internally includes a cavity. The grounding terminals are inserted in the cavity of the housing part. The conductive member is connected with a bottom portion of all the grounding terminals. The conductive member and the housing part are formed of a plastic material. The grounding terminals include a long row structure and a short row structure. With such configuration, the present invention is structurally improved. With the conductive member connected with the bottom portions of all the grounding terminals, all SAS and PCIe channels are applied simultaneously, so as to use six channels to achieve an x6 channel application.

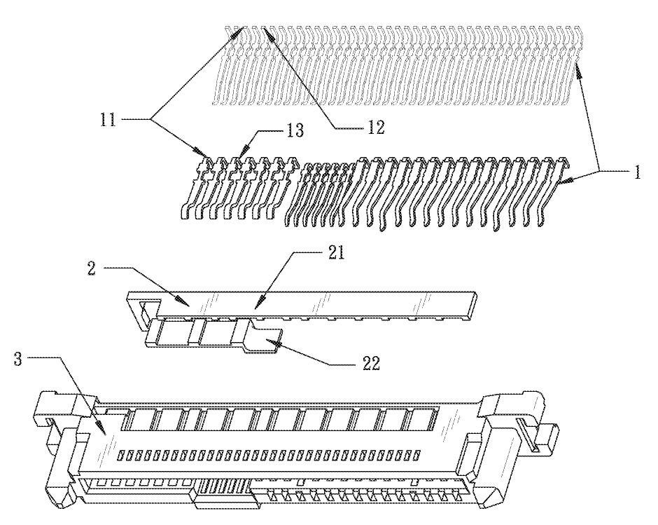

### BACKGROUND OF THE INVENTION

### 1. Field of the Invention

The present invention relates to U2 adapters, and more particularly, to an U2 female adapter with a special mask structure.

### 2. Description of the Related Art

An U2 adapter (SFF-8639 interface) is a new physical electrical interface designed for a high performance storage interface (presently in a form of a driver type SSD). With the pin definition basis (downward compatible for SATA/SAS hard drive) of SFF-8462 interface (physical electrical interface) remained, new definition of pins are added, wherein a single U2 interface is allowed to apply a PCIe x4 channel at most, so as to provide a basic condition of high performance transmission between the driver type SSD and the host machine.

A 2.5 inches PCIe SSD applying the U2 adapter realizes the hot plugging function, which enhances the maintainability for users of an information center. In addition, the U2 adapter standard includes PCIe, SATA, and SAS, such that the user is allowed to vary the configuration according to different user demands. Therefore, the U2 adapter gradually becomes a presently mainstream data transmission adapter.

However, when the SAS and PCIe channels in the U2 adapter are used simultaneously, an interference thereof occurs, thus affecting the overall performance of the adapter.

### SUMMARY OF THE INVENTION

For improving the issues above, the present invention discloses an U2 female adapter, which is structurally improved to resolve the interference occurring during a high speed signal transmission between the terminals.

For achieving the aforementioned objectives, the present invention provides an U2 female adapter, comprising:

a terminal part, the terminal part including a plurality of grounding terminals;

a conductive member; and

a housing part, the housing part including a cavity,

such that the grounding terminals are inserted in the cavity of the housing part, and the conductive member is connected with a bottom portion of the grounding terminals.

Preferably, the conductive member and the housing part are formed of a plastic material.

Preferably, the grounding terminals include a long row structure and a short row structure.

Preferably, the conductive member is formed in a U shape and includes a long side and a short side.

Preferably, when the conductive member is connected with the bottom portions of all the grounding terminals, the long row structure is conductively connected with the long side, and the short row structure is conductively connected with the short side.

Preferably, the conductive member is formed by a first processing step, and the housing part is formed by a second processing step, so as to optimize the manufacturing process.

With such configuration, the present invention is structurally improved. With the conductive member connected with the bottom portions of all the grounding terminals, all SAS and PCIe channels are applied simultaneously, so as to use six channels to achieve an x6 channel application.

### BRIEF DESCRIPTION OF THE DRAWINGS

The sole FIGURE is an exploded view of an U2 female adapter in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

Referring to the sole FIGURE, an U2 female adapter in accordance with an embodiment of the present invention comprises a terminal part 1, a conductive member 2, and a housing part 3. The terminal part 1 includes a plurality of grounding terminals 11. The housing part 3 internally includes a cavity.

The grounding terminals 11 are inserted in the cavity of the housing part 3.

The conductive member 2 is connected with a bottom portion of all the grounding terminals 11.

The conductive member 2 and the housing part 3 are formed of a plastic material.

The grounding terminals 11 include a long row structure 12 and a short row structure 13.

The conductive member 2 is formed in a U shape and includes a long side and a short side.

When the conductive member 2 is connected with the bottom portions of all the grounding terminals 11, the long row structure 12 is conductively connected with the long side 21, and the short row structure 13 is conductively connected with the short side 22.

The conductive member is formed by a first processing step, and the housing part is formed by a second processing step, so as to optimize the manufacturing process.

Although particular embodiments of the invention have been described in detail for purposes of illustration, various modifications and enhancements may be made without departing from the spirit and scope of the invention. Accordingly, the invention is not to be limited except as by the appended claims.

1. An U2 female adapter for SFF-8639 interface, comprising:
a terminal part, the terminal part including a plurality of grounding terminals;
a conductive member; and
a housing part, the housing part including a cavity,
wherein,
the grounding terminals are inserted in the cavity of the housing part, and the conductive member is connected with a bottom portion of the grounding terminals.

2. The U2 female adapter of claim 1, wherein,
the conductive member and the housing part are formed of a conductive plastic material.

3. The U2 female adapter of claim 2, wherein,
the grounding terminals include a long row structure and a short row structure.

4. The U2 female adapter of claim 3, wherein,
the conductive member is formed in a U shape and includes a long side and a short side.

5. The U2 female adapter of claim 4, wherein,
when the conductive member is connected with a bottom portion of all the grounding terminals, the long row structure is conductively connected with the long side, and the short row structure is conductively connected with the short side.
